(19) United States
(12) Patent Application Publication
(10) Pub. No.: US 2011/0205114 A1
(43) Pub. Date: Aug. 25, 2011

(54) SYSTEMS AND METHODS FOR DETECTING MULTIPLE GNSS SIGNALS

(76) Inventors: Joakim Landmark, Phoenix, AZ (US); Ronald Clayton Alford, Tempe, AZ (US)

(21) Appl. No.: 12/709,735

(22) Filed: Feb. 22, 2010

(51) Int. Cl. G01S 19/33

(52) U.S. Cl. 342/357.73

(57) ABSTRACT

A representative radio frequency (RF) receiver comprises an RF section that receives RF signals. Such RF signals include more than one global navigation satellite system (GNSS) signals, which include at least one of the following: global positioning system (GPS) signals, Galileo signals and Glonass signals. A mixer and converter section receives the RF signals from the RF section and includes a band stop filter and a harmonic reject mixer that facilitate detecting more than one GNSS signals from the RF signals. An intermediate frequency section amplifies and selects the detected more than one GNSS signals.

### TECHNICAL FIELD

The present disclosure is generally related to global navigation satellite system (GNSS) receivers.

### BACKGROUND

Today, it is important to consumers that wireless portable devices can receive RF signals in areas with many jammer bands. Many portable devices include global navigation satellite system (GNSS) receivers that enable the consumers to navigate from one place to another. The GNSS receivers operate in a frequency band that is close in band with, for example, cellular bands, which often interferes with the reception of GNSS signals.

Traditionally, the GNSS receivers use SAW filtering to remove any jammer when the GNSS receivers receive GNSS signals, e.g., Glonass signals. However, the SAW filters cost money, area and sensitivity. Thus, there is a continuing effort to minimize the need for and amount of SAW filtering required for the GNSS receiver.

### SUMMARY

A representative radio frequency (RF) receiver comprises an RF section that receives RF signals. Such RF signals include more than one global navigation satellite system (GNSS) signals, which include at least one of the following: global positioning system (GPS) signals, Galileo signals and Glonass signals. A mixer and converter section receives the RF signals from the RF section and includes a band stop filter and a harmonic reject mixer that facilitate detecting more than one GNSS signals from the RF signals. An intermediate frequency section amplifies and selects the detected more than one GNSS signals.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram that illustrates a system having a global navigation satellite system (GNSS) navigation device in accordance with an embodiment of the disclosure;

FIG. 2 is a block diagram that illustrates an exemplary radio frequency (RF) receiver in accordance with an embodiment of the disclosure;

FIG. 3 is a more detailed block diagram that illustrates a radio frequency receiver in accordance with an embodiment of the disclosure; and

FIGS. 4 and 5 are graphs that illustrate a standard mixer and a harmonic reject mixer, respectively, for rejecting jammer bands in accordance with an embodiment of the disclosure.

### DETAILED DESCRIPTION

Exemplary systems and devices are discussed with reference to the figures. Although these systems and devices are described in detail, they are provided for purposes of illustration only and various modifications are feasible.

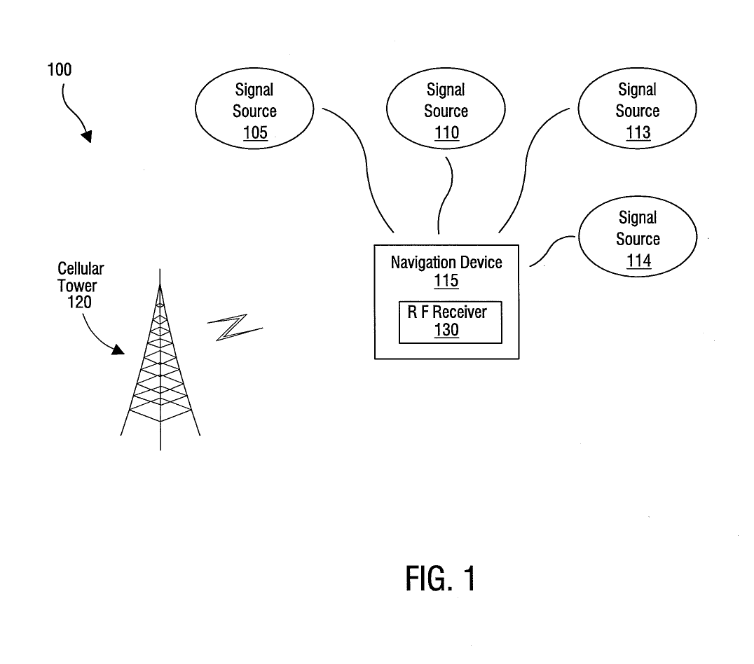

FIG. 1 is a block diagram that illustrates a system 100 having a global navigation satellite system (GNSS) navigation device 115 that is capable of receiving more than one global navigation satellite system (GNSS) signal. A simple system 100 includes a plurality of signal sources 105, 110, 113, 114 and a navigation device 115. Alternatively or additionally, a more complex system 100, such as an assisted global positioning system (AGPS), further comprises a base station (not shown) and a server (not shown). Although only one navigation device 115 is shown in the system 100, the system 100 can include multiple navigation devices.

The signal sources 105, 110, 113, 114 include global positioning system (GPS) satellites, Galileo satellites, and Glonass satellites, among others. The plurality of signal sources 105, 110, 113, 114 can transmit GNSS signals, such as, GPS signals, Galileo signals and Glonass signals. The signal sources 105, 110, 113, 114 generally orbit above the location of the navigation devices 115 at any given time. The navigation devices 115 include, but are not limited to, RF receivers 130, cell phones with embedded signal receivers, and personal digital assistants (PDAs) with embedded signal receivers, among others. The signal sources 105, 110, 113, 114 transmit signals to the navigation devices 115, which use the signals to determine the location, speed, and heading of the navigation devices 115.

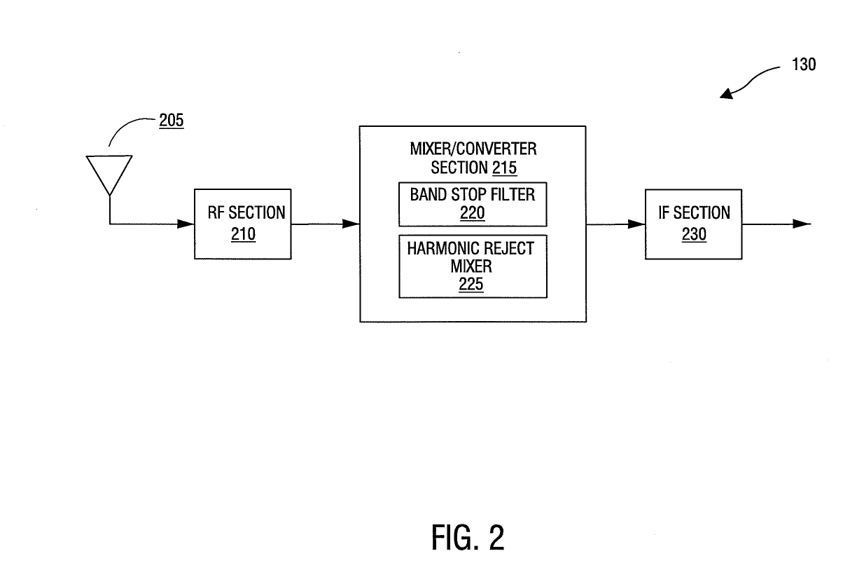

A cellular tower 120 is shown to illustrate a presence of cellular bands that can jam the RF receiver 130 from receiving GNSS signals. The RF receiver 130 includes band stop filter 220 (FIG. 2) and harmonic reject mixer 225 (FIG. 2) that provide jammer immunity. The RF receiver 130 is further described in connection with FIGS. 2-5.

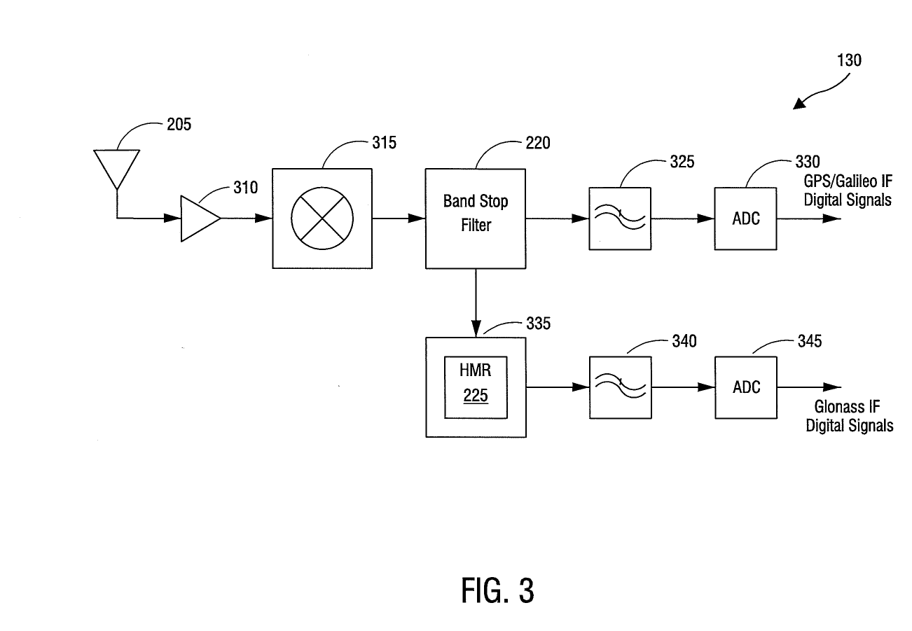

FIG. 2 is a block diagram that illustrates an exemplary radio frequency (RF) receiver 130 having a band stop filter 220 and a harmonic reject mixer 225. The RF receiver 130 comprises an RF section 210 that receives RF signals from an antenna 205. The received RF signals include more than one GNSS signals, which include at least one of the following: GPS signals, Galileo signals and Glonass signals. A mixer and converter section 215 receives the RF signals from the RF section 210 and includes the band stop filter 220 and the harmonic reject mixer 225 that facilitate detecting more than one GNSS signals from the RF signals. An intermediate frequency section 230 amplifies and selects the detected more than one GNSS signals. The band stop filter 220 and the harmonic reject mixer 225 are further described in connection with FIG. 3.

FIG. 3 is a more detailed block diagram that illustrates a radio frequency (RF) receiver 130 that can reduce interference from jammer bands. The antenna 205 receives the RF signals and sends them to a low noise amplifier (LNA) 310, which amplifies and filters the RF signals. The LNA 310 can include a high QLC filtering on the LNA output. A first down conversion 315 receives the amplified RF signals and converts the RF signals to intermediate frequency (IF) signals, which, in this example, is optimized for the GPS signals and/or Galileo signals. It should be noted that the first down conversion 315 can include a voltage switching mixer or a current switching mixer, or both.

For jammer immunity in the cellular bands, such as, signals in the 1710-1780 MHz (denoted 1800 MHz) and 1850-1930 MHz (denoted 1900 MHz), the first down conversion 315 includes filters that provide a slow roll off, resulting in low attenuation of the close in jammer bands, such as, 1800 and 1900 MHz, and high attenuation of the far off jammer bands, such as, 900 MHz, 2100 MHz, ISM bands, etc. The band stop filter 220 can provide a high rejection of the close in jammer band, e.g., 1800 MHz, and little rejection at, e.g., 1900 MHz band, and no rejection of the far away bands. Thus, the first down conversion 315 and the band stop filter 220 provide a good filter function that gives sufficient jammer immunity for the GPS/Galileo path through intermediate frequency (IF) filter(s) 325 and analog-to-digital converter(s) 330.

For the Glonass signals, the band stop filter 220 send the Glonass signals to a second down conversion 335, which converts the RF signals to intermediate frequency (IF) signals and is optimized for the Glonass signals. It should be noted that current switching mixer (not shown) can be used for linearity, but in a switching mixer the local oscillator (not shown) can have a lot of harmonics that can convert jammers to baseband. According, a harmonic rejecting mixer 225 can be used to reject 3^{rd}, 5^{th}, 11^{th}, 13^{th} harmonics, etc of the local oscillator. Thus, the jamming cellular band can mixed with the rejected harmonics of a local oscillator, which facilitates reducing and/or eliminating the jamming cellular band from the Glonass path through intermediate frequency (IF) filter(s) 340 and analog-to-digital converter(s) 345.

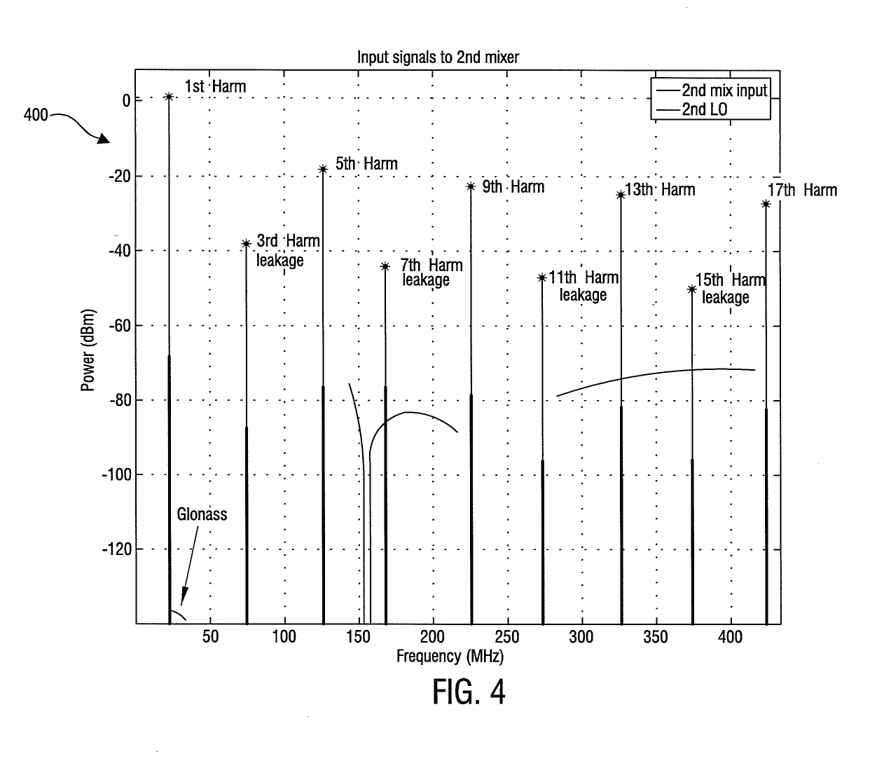

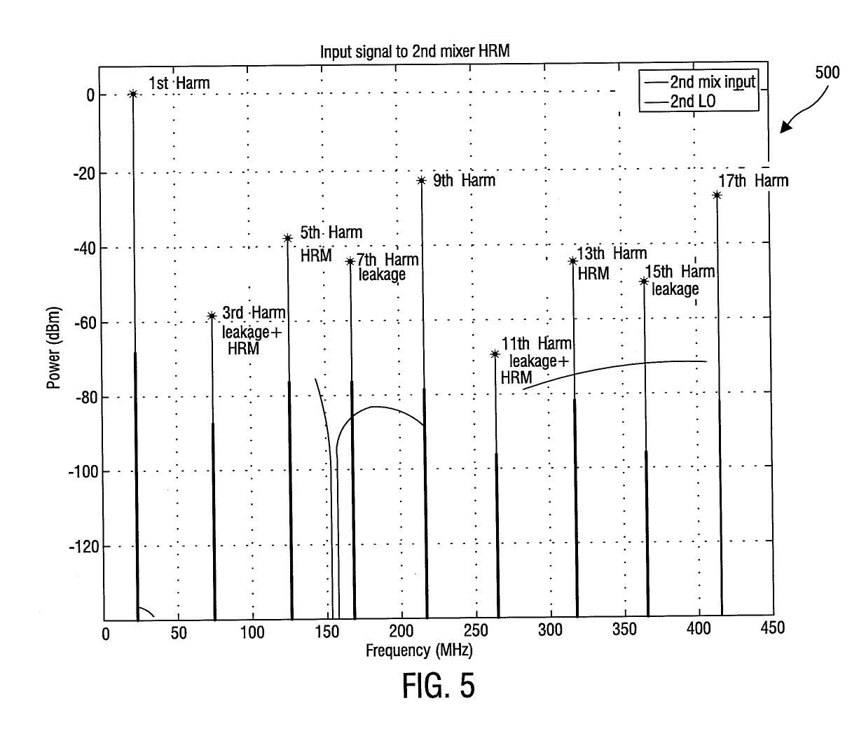

For example, the close in jammer band, 1800 MHz band, can be mixed with the rejected 5^{th} and 7^{th} harmonics of the local oscillator and the 1900 MHz band can be mixed with the rejected 13^{th} and 15^{th} harmonics of the local oscillator. The rejected harmonics are further shown and described in connection with FIGS. 4 and 5. In general, the band stop filter 220 can suppress the close in jammer band, e.g., 1800 MHz band, and the harmonic reject mixer 225 can suppress the far away jammer band, e.g., 1900 MHz band or greater frequency. It should be noted that the second down conversion can further include a voltage switching mixer or a current switching mixer, or both.

FIGS. 4 and 5 are graphs 400, 500 that illustrate a standard mixer and a harmonic reject mixer 225, respectively, for rejecting far away jammer bands. Both graphs 400, 500 show the harmonics of the local oscillator. However, graph 500 of the harmonic reject mixer 225 shows that every other odd harmonic, e.g., 3^{rd}, 5^{th}, 11^{th}, and 13^{th} harmonics, can be more suppressed by the image rejection than using a standard mixer.

Graph 500 shows that the 3^{rd}, 5^{th}, 11^{th} and 13^{th} harmonics are suppressed by approximate 20 dB using the harmonic reject mixer 225. It should be noted that instead of using the harmonic reject mixer 225 the stop band of the band stop filter 220 can be increased such that the 13^{th} harmonic mixes with the 1900 MHz band. That may, however, lead to other complexities which will not be discussed in this disclosure.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A radio frequency (RF) receiver comprising:
an RF section that receives RF signals, wherein the RF signals include more than one global navigation satellite system (GNSS) signals, the GNSS signals include at least one of the following: global positioning system (GPS) signals, Galileo signals and Glonass signals;
a mixer and converter section that receives the RF signals from the RF section, wherein the mixer and converter section includes a band stop filter and a harmonic reject mixer that facilitate detecting more than one GNSS signals from the RF signals; and
an intermediate frequency section that amplifies and selects the detected more than one GNSS signals.

2. The RF receiver as defined in claim 1, wherein the mixer and converter section further includes a first down conversion that converts the RF signals to intermediate frequency (IF) signals and is optimized for the GPS signals and/or Galileo signals.

3. The RF receiver as defined in claim 2, wherein the first down conversion includes a voltage switching mixer or a current switching mixer.

4. The RF receiver as defined in claim 2, wherein the mixer and converter section further includes a second down conversion that receives the RF signals from the band stop filter, wherein the second down conversion converts the RF signals to intermediate frequency (IF) signals and is optimized for the Glonass signals.

5. The RF receiver as defined in claim 4, wherein the second down conversion includes the harmonic reject mixer that rejects certain harmonics of a local oscillator.

6. The RF receiver as defined in claim 4, wherein the second down conversion includes a voltage switching mixer or a current switching mixer.

7. The RF receiver as defined in claim 4, wherein the mixer and converter section further includes GPS/Galileo intermediate frequency filters and GPS/Galileo analog-to-digital converters that receives the IF signals from the band stop filter, and Glonass intermediate frequency filters and Glonass analog-to-digital converters that receives the IF signals from the second down conversion.

8. A radio frequency (RF) receiver comprising:
an RF section that receives RF signals, wherein the RF signals includes more than one global navigation satellite system (GNSS) signals, the GNSS signals include at least one of the following: global positioning system (GPS) signals, Galileo signals and Glonass signals;
a mixer and converter section that receives the RF signals from the RF section, wherein the mixer and converter section includes a first down conversion that converts the RF signals to intermediate frequency signals and is optimized for the GPS signals and/or Galileo signals, a band stop filter and a harmonic reject mixer that facilitate detecting more than one GNSS signals, and a second down conversion that converts the RF signals to intermediate frequency signals and is optimized for the Glonass signals; and
an intermediate frequency section that amplifies and selects the detected more than one GNSS signals.

9. The RF receiver as defined in claim 8, wherein the first down conversion includes a voltage switching mixer or a current switching mixer.

10. The RF receiver as defined in claim 8, wherein the second down conversion includes the harmonic reject mixer that rejects certain harmonics of a local oscillator.

11. The RF receiver as defined in claim 8, wherein the second down conversion includes a voltage switching mixer or a current switching mixer.

12. The RF receiver as defined in claim 8, wherein the mixer and converter section includes GPS/Galileo intermediate frequency filters and GPS/Galileo analog-to-digital converters that receive the IF signals from the band stop filter, and Glonass intermediate frequency filters and Glonass analog-to-digital converters that receive IF signals from the second down conversion.

13. A navigation device comprising:
an RF section that receives RF signals, wherein the RF signals include more than one global navigation satellite system (GNSS) signals, the GNSS signals include at least one of the following: global positioning system (GPS) signals, Galileo signals and Glonass signals;
a mixer and converter section that receives the RF signals from the RF section, wherein the mixer and converter section includes a band stop filter and a harmonic reject mixer that facilitate detecting more than one GNSS signals from the RF signals; and
an intermediate frequency section that amplifies and selects the detected more than one GNSS signals.

14. The navigation device as defined in claim 13, wherein the mixer and converter section further includes a first down conversion that converts the RF signals to intermediate frequency (IF) signals and is optimized for the GPS signals and/or Galileo signals.

15. The navigation device as defined in claim 14, wherein the first down conversion includes a voltage switching mixer or a current switching mixer.

16. The navigation device as defined in claim 14, wherein the mixer and converter section further includes a second down conversion that receives RF signals from the band stop filter, wherein the second down conversion converts the RF signals to intermediate frequency (IF) signals and is optimized for the Glonass signals.

17. The navigation device as defined in claim 16, wherein the second down conversion includes the harmonic reject mixer that rejects certain harmonics of a local oscillator.

18. The navigation device as defined in claim 16, wherein the second down conversion includes a voltage switching mixer or a current switching mixer.

19. The navigation device as defined in claim 16, wherein the mixer and converter section further includes GPS/Galileo intermediate frequency filters and GPS/Galileo analog-to-digital converters that receives the RF signals from the band stop filter, and Glonass intermediate frequency filters and Glonass analog-to-digital converters that receives RF signals from the second down conversion.
